(19) United States
(12) Patent Application Publication
(10) Pub. No.: US 2015/0131139 A1
(43) Pub. Date: May 14, 2015

(54) OPTICAL ELEMENT

(71) Applicant: CANON KABUSHIKIK KAISHA, Tokyo (JP)

(72) Inventors: Masami Tsukamoto, Yokohama-shi (JP); Miki Ueda, Tokyo (JP)

(21) Appl. No.: 14/396,208

(22) PCT Filed: Apr. 1, 2013
(86) PCT No.: PCT/JP2013/060568

§ 371 Date: Oct. 22, 2014

(30) Foreign Application Priority Data
Apr. 24, 2012 (JP) 2012-099135

(51) Int. Cl. G02F 1/155; G02B 5/18

(52) U.S. Cl. CPC G02F 1/155; G02B 5/1828
USPC 359/266

(57) ABSTRACT

Provided is an optical element that can generate and extinguish a diffraction grating and can change the grating pitch of the appearing diffraction grating. The optical element includes a pair of opposing substrates, a plurality of electrodes arranged on one of the substrates, an electrochromic layer disposed so as to be in contact with the plurality of electrodes, and a counter electrode disposed so as to oppose the plurality of electrodes with the electrochromic layer therebetween. The optical element further includes insulating layers each disposed between the substrate and one of two adjacent electrodes in the plurality of electrodes and each having a thickness larger than that of the other electrode of the two adjacent electrodes.

### TECHNICAL FIELD

The present invention relates to an optical element including an electrochromic material.

### BACKGROUND ART

A diffraction grating is an optical element that is used for dividing light beams by the phenomenon of light diffraction and extracting a light beam having a specific wavelength. The diffraction phenomenon occurs by a certain difference between the optical paths of the light beams partially passed through or reflected by a diffraction grating and the residual light beams. Accordingly, the diffraction grating can be prepared by, in the simplest way, arranging thin metallic wire at equal intervals, forming grooves having a certain depth at equal intervals on a transparent substrate, or similarly forming grooves or serrated protrusions having a certain depth at equal intervals on a reflective substrate. In general, since these structures cannot be changed, the diffraction wavelength or the diffraction angle is hardly shifted. In addition, it is difficult to switch a state of the diffraction grating being present to a state of the diffraction grating being absent to show transparency or uniform reflection or not to transmit light at all.

In contrast, PTL 1 proposes an optical element that has a diffraction grating including an electrochromic material and can switch between a transparent state of the diffraction grating being absent and a state of the diffraction grating being present. Furthermore, it is proposed to change the pitch of the diffraction grating to twice the original one by controlling the coloring through application of a voltage to every other grating.

Specifically, as shown in FIG. 10A, the optical element described in PTL 1 includes two substrates 1a and 1b bonded to each other via a spacer 7. Electrodes are disposed inside the substrates, and an electrochromic solution 14 is enclosed between the substrates. In the interior of the opposing substrates, a diffraction grating pattern having a pitch X is formed with a transparent electrode material as coloring electrodes 12 on one substrate 1a, and a counter electrode 13 is formed on the other substrate 1b in the periphery of the substrate in such a manner that the electrode 13 does not invade the optical path. The electrochromic solution is, for example, of a viologen compound or silver iodide. A coloring material precipitates on the coloring electrodes 12 by applying a coloring potential to the coloring electrodes 12 and a reversal potential to the counter electrode 13 of the optical element. As a result, a diffraction grating having the pitch X appears. The coloring material dissolves by applying reversed polarities of the potentials to the counter electrode and the coloring electrodes, resulting in discoloring and disappearance of the diffraction grating. Furthermore, it is also described that, as shown in FIG. 10(B), electrodes forming the gratings of a diffraction grating are alternately wired to provide two groups 12c and 12d of electrodes. A diffraction grating having a pitch X appears by applying a coloring potential to both electrodes, and a diffraction grating having a pitch 2X appears by applying a coloring potential to the electrodes 12c or the electrodes 12d only.

The optical element described in PTL 1, however, has the following disadvantages. The diffraction grating shown in FIG. 10B can merely change the pitch of the diffraction grating to be twice the basic pitch X. Furthermore, even if coloring and discoloring are controlled by independently applying a potential to each electrode of the diffraction grating, the pitch of a diffraction grating can be merely changed to integral multiplication of the basic pitch X.

In addition, the ratio of the coloring portion per one pitch of the diffraction grating is decreased with an increase of the pitch being integral multiplication of the basic pitch. For example, in FIG. 10B, a diffraction grating with a pitch 2X appears by applying a coloring potential to the electrodes 12c only. The width of the coloring portion is the width of the electrode, and the discoloring portion is (2X−(width of electrode)). Consequently, the area where light passes through occupies an area not less than a half of the pitch of the diffraction grating. The widening of the discoloring portion, i.e., the width of the light transmitting portion, causes a problem of decreasing the performance of extracting monochromatic light by the diffraction grating. This disadvantage may be avoided by coloring or discoloring two or more electrodes as a set. However, since the spaces between the electrodes are not colored, unnecessary diffracted light is generated in the spaces when it is used as a diffraction grating.

Furthermore, transparent electrode materials, such as ITO and IZO, that are usually used for transmitting visible light slightly absorb visible light. Accordingly, in an element structure shown in FIG. 10A, a slight difference in absorption occurs between the portion having the electrode and the portion not having the electrode even in a transparent state, which causes problems of uneven transmission in the optical path plane and occurrence of slight diffraction thereby.

### CITATION LIST

### Patent Literature

PTL 1 Japanese Patent Laid-Open No. 10-197904

### SUMMARY OF INVENTION

The present invention provides an optical element that can generate and extinguish a diffraction grating and can vary the grating pitch of the appearing diffraction grating.

The optical element according to the present invention includes a pair of opposing substrates, a plurality of electrodes arranged on one of the substrates, an electrochromic layer disposed so as to be in contact with the electrodes, and a counter electrode disposed so as to oppose the electrodes with the electrochromic layer therebetween. Furthermore, one of two adjacent electrodes in the plurality of electrodes is provided with an insulating layer between the electrode and the substrate, and the insulating layer has a thickness larger than that of the other electrode of the two adjacent electrodes.

Further features of the present invention will become apparent from the following description of exemplary embodiments with reference to the attached drawings.

### Advantageous Effects of Invention

The present invention can provide an optical element that can generate and extinguish a diffraction grating and can vary the grating pitch of the appearing diffraction grating.

### BRIEF DESCRIPTION OF DRAWINGS

FIGS. 1A and 1B are schematic diagrams illustrating an example of the optical element of the present invention.

FIGS. 2A to 2D are schematic diagrams illustrating the coloring state of the optical element shown in FIGS. 1A and 1B.

FIGS. 3A to 3C are schematic diagrams illustrating another example of the optical element of the present invention.

FIGS. 4A to 4C are schematic diagrams illustrating another example of the optical element of the present invention.

FIG. 5 is a schematic diagram illustrating another example of the optical element of the present invention.

FIGS. 6A to 6C are schematic diagrams illustrating an optical element, of the present invention, including an insulating layer made of an EC material.

FIGS. 7A to 7D are schematic diagrams illustrating another example of the optical element of the present invention.

FIG. 8 is a schematic diagram illustrating another example of the optical element of the present invention.

FIG. 9 is a schematic diagram illustrating another example of the optical element of the present invention.

FIGS. 10A and 10B are schematic diagrams illustrating a known optical element.

### DESCRIPTION OF EMBODIMENTS

Embodiments of the present invention will now be described in detail.

The structures of optical elements according to the present invention are roughly classified into two types depending on the electrochromic material used. One type of the optical elements uses a solution precipitation-type electrochromic material, and such an optical element includes a pair of opposing substrates, a plurality of electrodes arranged on one of the substrates, a counter electrode disposed so as to oppose the plurality of electrodes, and an electrochromic solution enclosed between the plurality of electrodes and the counter electrode. Furthermore, insulating layers are disposed between the substrate and every other electrode of the plurality of electrodes. The insulating layers each have a thickness larger than that of the adjacent electrodes.

The adjacent electrodes in the plurality of electrodes can have distances from the substrate different from each other. Specifically, the plurality of electrodes each have a thickness of 30 nm or more from the viewpoint of conductivity and 500 nm or less from the viewpoint of transmittance, such as a thickness of 50 nm or more and 300 nm or less. The insulating layer has a thickness of 100 nm or more for achieving sufficient insulation and 5000 nm or less from the viewpoint of efficient use of light, such as 300 nm or more and 1000 nm or less.

Each of the plurality of electrodes can have a region overlapping an adjacent electrode.

The plurality of electrodes are patterned linear electrodes and can generate a diffraction grating by being applied with a coloring voltage and a discoloring voltage.

In the diffraction grating generated by the plurality of electrodes, the distances of the discoloring portions, i.e., the openings between gratings, from the substrate are approximately the same.

The other type of the optical elements includes a solid electrochromic material and includes, as in the optical element of the solution precipitation-type electrochromic material, a plurality of electrodes on one of substrates, a counter electrode, solid electrochromic layers disposed so as to be in contact with the plurality of electrodes, and an electrolyte enclosed between the solid electrochromic layers and the counter electrode. When the thicknesses of the plurality of electrodes having different distances from the substrate are the same, and the thicknesses of the solid electrochromic layers are the same, the refractive index n(I) and the thickness T(I) (nm) of the insulating layer can satisfy the relationship of Expression (1):

|(n(P)/(1−(sin θ/n(P))²)^{1/2}−n(I)/(1−(sin θ/n(I))²)^{1/2})×T(I)|≦(n±¼)λ (1),

wherein, n in (n±¼) represents an integer of 0 or more, n(P) represents the refractive index of the electrolyte, λ represents the wavelength (nm) of incident light, and θ represents the incident angle (°) from the direction orthogonal to the optical element.

When the electrochromic layer is made of a solution precipitation-type electrochromic material and the thicknesses of the plurality of electrodes having different distances from the substrate are the same, the refractive index n(I) and the thickness T(I) (nm) of the insulating layer can satisfy the relationship of Expression (2):

|(n(E)/(1−(sin θ/n(E))²)^{1/2}−n(I)/(1−(sin θ/n(I))²)^{1/2})×T(I)|≦(n±¼)λ (2),

wherein, n in (n±¼) represents an integer of 0 or more, n(E) represents the refractive index of the electrochromic solution, λ represents the wavelength (nm) of incident light, and θ represents the incident angle (°) from the direction orthogonal to the optical element.

The interval between the plurality of electrodes can be a half or less of the wavelength used.

A diffraction grating appears by selectively applying a coloring voltage to some of the patterned electrodes and applying a discoloring voltage to the remaining electrodes. The grating pitch of the appearing diffraction grating is varied by changing the combination of the electrodes applied with the coloring voltage and the electrodes applied with the discoloring voltage. The diffraction grating disappears by applying a discoloring voltage to all electrodes to transmit incident light and disappears by applying a coloring voltage to all electrodes to absorb, diffuse, or reflect incident light.

An electrochromic element performs coloring and discoloring using the electrochemical redox reaction of an electrochromic material and can reversibly perform the coloring and discoloring by voltage application to the material. The present invention provides an optical element having a diffraction grating that can appear and disappear using the electrochromic element and having a high degree of freedom in variation of the pitch of the appearing diffraction grating.

The electrochromic element basically has a structure having two substrates, electrodes (coloring electrodes) formed on one of the substrates, a counter electrode formed on the other substrate, and an electrochromic layer containing an electrochromic material, and the structure formed by bonding the substrates to each other via a spacer such that the electrodes lie in the interior and the electrochromic layer is enclosed therein.

The structure of the electrochromic layer (hereinafter, may be abbreviated as EC layer) is roughly classified into two types depending on the electrochromic (hereinafter, may be abbreviated as EC) material used. One type is that of an element including a solid EC material, and the other type is that of an element including a solution precipitation-type EC material.

In the element of a solid EC material, a film of the EC material is formed on an electrode and is brought into contact with an electrolyte. Coloring and discoloring are caused by movement of charges and ions between the EC material and the electrolyte by means of a voltage. A most simple EC element has a structure including coloring electrodes and an EC layer disposed on one substrate, a counter electrode disposed on the other substrate, and an electrolyte enclosed between the EC layer and the counter electrode. Examples of the solid electrochromic material include metal oxides such as tungsten oxide, molybdenum oxide, vanadium oxide, titanium oxide, and niobium oxide; and metal complex compounds such as Prussian blue and phthalocyanine compounds. These can be formed into films by, for example, vapor deposition, sputtering, electrolytic deposition, or spin coating. In order to generate a diffraction grating, a material that can be used as a film having a relatively small thickness and shows a large difference in color density between coloring and discoloring is used.

The other type is a solution precipitation-type EC material such as a viologen compound or silver iodide. The EC material is used in a solution state and precipitates on an electrode by applying a voltage to the electrode. A most simple solution precipitation-type EC element has a structure where an EC material in the solution state is enclosed between opposing electrodes provided with electrodes, as shown in PTL 1. In order to be used in a diffraction grating, a material that precipitates on an electrode and can form a clear pattern is used. Accordingly, a material that can precipitate on a substrate at a relatively small thickness and shows a high color density is used. In particular, considering the optical properties in coloring and discoloring, a material that has a sufficiently high color density to the wavelength used in the coloring and absorbs less light in the discoloring is selected.

In optical elements using electrochromic elements, there are a transmission type and a reflection type. In both types, the substrate on the light-transmitting side is required to be transparent to the light having the wavelength used. In general, optical glass is used as such a substrate. In addition, the electrode that is present in the optical path and is used for coloring and discoloring is required to be transparent to the light having the wavelength used during the discoloring. Furthermore, the electrode is required not to affect the electrochromic reaction and not to deteriorate itself. In general, a transparent electrode material such as ITO or IZO is used. The electrode disposed outside the optical path and not required to be transparent may be made of an electrode material such as a metal or carbon. In a metal material, however, it is important to select a material that does not prevent the chemical reaction and does not deteriorate the electrode itself.

As a liquid electrolyte, a solution of an organic solvent such as propylene carbonate, ethylene carbonate, sulfolane, γ-butyrolactone, dimethylformamide, dimethylsulfoxide, tetrahydrofuran, or dimethoxyethane or a mixture thereof dissolving an alkali metal salt or quaternary ammonium salt therein is used.

In addition to the liquid electrolyte, a solid electrolyte or a gel electrolyte can be used. Examples of the solid electrolyte include polymer solid electrolytes where an alkali metal salt or quaternary ammonium salt is dissolved in a polymer matrix such as polyethylene oxide or polyoxyethylene glycol polymethacrylate. The gel electrolyte is, for example, those prepared by crosslinking an acrylic monomer and a solution containing a supporting electrolyte.

In the present invention, in order to provide a diffraction grating having a high degree of freedom in variation of the grating pitch, the coloring electrodes are patterned in a line form and are arranged such that adjacent electrodes have different distances from the substrate with insulating layers disposed between the electrodes and the substrate. This allows independent application of a voltage to electrodes adjacent to each other. As a result, coloring and discoloring of the grating portion and the portion between gratings of the diffraction grating can be freely controlled to provide an optical element that can generate a diffraction grating capable of changing the grating pitch with a high degree of freedom in variation of the pitch.

The coloring electrode can be patterned by, for example, lithography. The insulating layer disposed between coloring electrodes is required to be transparent to light having the wavelength used and is usually made of, for example, SiO₂ or SiN. However, in many cases, the refractive index of the insulating layer is required to satisfy a certain relationship with the refractive indices and the thicknesses of the electrode material and the electrolyte. Accordingly, a transparent insulating material having an appropriate refractive index is used as necessary. The appropriate refractive index varies depending on the structures of the electrode layer, insulating layer, and electrochromic layer.

The optical element of the present invention can generate and extinguish a diffraction grating by means of the electrochromic element and can change the grating pitch of the generated diffraction grating. In the optical element of the present invention, at least a part of the electrodes generating the diffraction grating pattern are arranged such that insulating layers are disposed between the part of the electrodes and the substrate and thereby that the distance from the substrate in the direction orthogonal to the substrate is different from that of the adjacent electrodes. Consequently, each electrode can independently perform coloring and discoloring by applying different potentials to the adjacent electrodes, and the degree of freedom in variation of the grating pitch is high. The diffraction grating of the present invention can adjust the wavelength resolution and can prevent occurrence of unnecessary diffracted light. Furthermore, it is possible to provide a wave plate that can generate and extinguish polarization properties and can adjust the degree of polarization by generating a diffraction grating having a pitch not higher than the wavelength.

### EXAMPLES

The present invention will now be specifically described by way of examples.

### Example 1

An example of applying the present invention to a transmission type diffraction grating including a solid electrochromic material will be described.

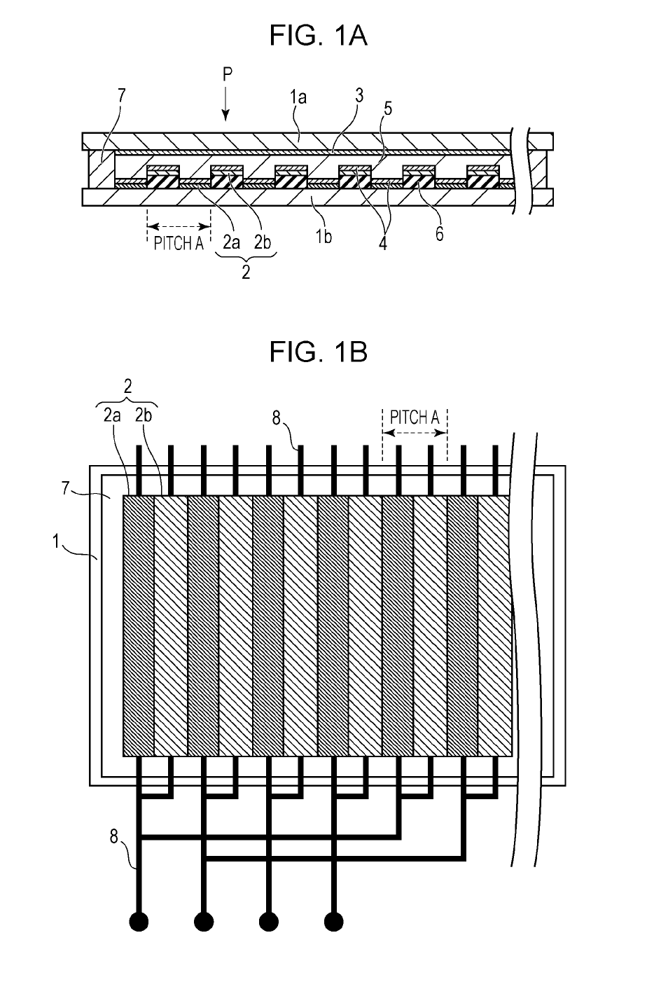

FIGS. 1A and 1B are schematic diagrams illustrating an example of the optical element of the present invention. FIG. 1A is a cross-sectional view schematically illustrating the optical element of the present invention. The optical element of the invention includes a pair of opposing transparent substrates 1a and 1b disposed with a spacer 7 therebetween, a plurality of coloring electrodes 2 patterned in a diffraction grating form on the substrate 1a, a counter electrode 3 disposed on the inner surface of the substrate 1b, an EC layer 4 disposed so as to be in contact with the coloring electrodes 2, and an electrolyte liquid 5 enclosed between the EC layer 4 and the counter electrode 3.

FIG. 1B is a schematic diagram of the coloring electrodes 2 viewed from the optical path P side. The coloring electrodes are composed of two types of electrodes 2a and 2b alternately arranged in parallel at a pitch A with almost no gaps therebetween. The electrodes 2a are formed on the substrate, and the electrodes 2b are formed on insulating layers 6 disposed on the substrate. Thus, the electrodes 2a and 2b are arranged with different distances from the substrate via the insulating layers 6. The EC layer 4 having a certain thickness is stacked on each electrode. The insulating layers 6 each have a thickness larger than the thickness of the electrode 2a, such as larger than the total thickness of the electrode 2a and the EC layer disposed on the electrode 2a, so that the electrodes 2a and the electrodes 2b are insulated from each other and that different potentials can be applied to them.

Each electrode is wired so that coloring and discoloring can be performed according to the diffraction grating arrangement intended to be colored. Reference number 8 indicates the wiring of electrode. According to an intended diffraction grating pattern, a coloring potential is applied to electrodes corresponding to the gratings, and a discoloring potential is applied to electrodes corresponding to the openings, i.e., portions through which light passes. The pitch of a diffraction grating generated is varied by changing the combination of the electrodes applied with the coloring potential and the electrodes applied with the discoloring potential. The diffraction grating disappears by applying a discoloring potential to all electrodes to allow incident light to pass through. In contrast, the entire surface is colored and the diffraction grating disappears by applying the coloring potential to all electrodes, and the optical element functions as a beam stopper or a wavelength filter absorbing light in a specific wavelength region.

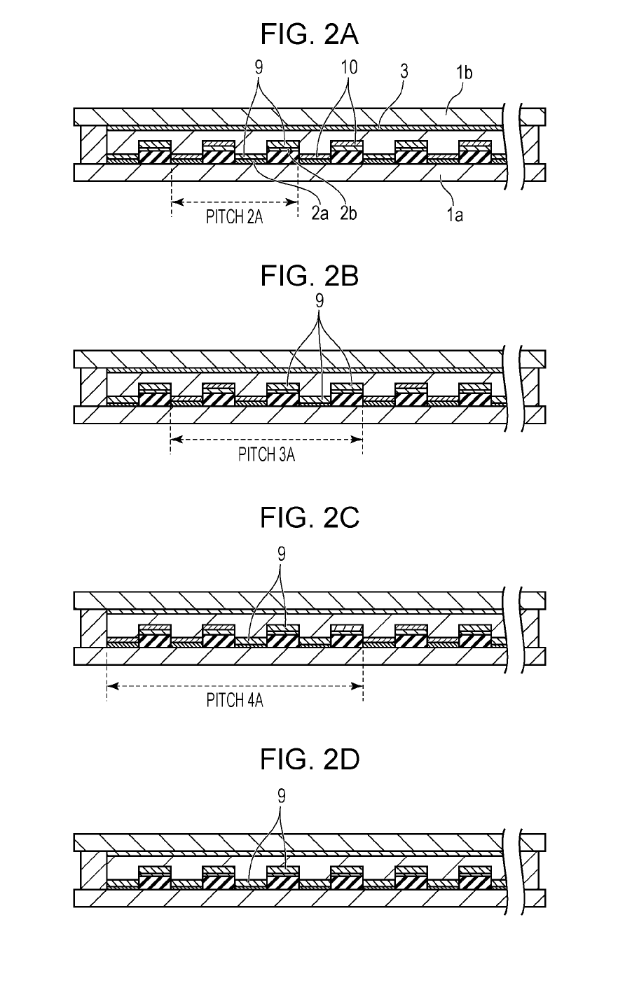

FIGS. 2A to 2D are schematic diagrams illustrating the coloring state of the optical element in Example 1 of the present invention. FIGS. 2A, 2B, and 2C illustrate states of the appearing diffraction gratings having pitches of 2A, 3A, and 4A, respectively, and FIG. 2D illustrates a state of coloring the entire surface. In FIG. 2A, a diffraction grating having a pitch 2A appears by alternately applying a coloring potential and a discoloring potential to sets of electrodes, each set consisting of adjacent electrode 2a and electrode 2b. Reference number 9 indicates a coloring portion, and reference number 10 indicates a discoloring portion. FIG. 2B shows appearance of a diffraction grating having a pitch 3A. FIG. 2C shows appearance of a diffraction grating having a pitch 4A. The openings of these diffraction gratings have widths of A, 1.5A, and 2A, which are respectively halves of the pitches of the diffraction gratings shown in FIGS. 2A, 2B, and 2C. Thus, the ratio of the opening width is constant even if the grating pitch is varied. Therefore, it is possible to change the pitch without reducing the resolution performance of the diffraction grating.

In the transmission type diffraction grating, an optical path difference causes diffraction of light passed through each opening portion. Accordingly, the opening is required not to cause a difference between optical paths of light passing therethrough. In optical elements shown in FIGS. 2A to 2C, one opening includes the electrode 2a portion and the electrode 2b portion. Therefore, it is necessary not to cause a difference between the optical paths of light passing through the electrode 2a portion and light passing through the electrode 2b portion. Accordingly, the difference in refractive index of the materials for the insulating layer and the electrolyte layer needs to be small.

In a case where the EC layers 4 are made of a solid EC material, an electrolyte layer 5 is disposed so as to be in contact with the EC layers 4, the electrode 2a and the electrode 2b, which have different distances from the substrate, have approximately the same thicknesses, and the EC layer 4 has approximately the same thickness as those of the electrodes 2a and 2b, the difference Δ between the optical paths of light passing through the electrode 2a portion and light passing through the electrode 2b portion is expressed by the following Expression (1a):

Δ=|(n(P)/(1−(sin θ/n(P))²)^{1/2}−n(I)/(1−(sin θ/n(I))²)^{1/2})×T(I)|(n±¼)λ (1a),

wherein, n in (n±¼) represents an integer of 0 or more, n(P) represents the refractive index of the electrolyte layer, λ represents the wavelength of incident light (nm), θ represents the incident angle (°) from the direction orthogonal to the optical element, n(I) represents the refractive index of the insulating layer, and T(I) represents the thickness (nm) of the insulating layer. The optical path difference Δ needs to be ¼λ or less or (n±¼)λ or less.

From Expression (1a) above, the optical path difference Δ can be reduced by selecting, as the material for the insulating layer, a material having a refractive index showing a less difference with that of the electrolyte layer. When the refractive index difference between the insulating layer and the electrolyte layer is small, the optical path difference Δ is approximately expressed by Expression (3):

Δ=|(n(P)−n(I))×T(I)/cos θ|≦(n±¼)λ (3)

(n in (n±¼) represents an integer of 0 or more).

In the case of a structure where a film, e.g., a solid EC film, has a relatively low thickness of about several hundred nanometers in a visible light region (λ=400 to 800 nm) and incident light enters at an approximately orthogonal angle, the influence by the optical path difference can be suppressed by reducing the refractive index difference between the insulating layer and the electrolyte layer to about 0.2 or less. In the case of an EC film having a large thickness, it is necessary to further reduce the refractive index difference for a larger incident angle. In general, the electrolyte layers have refractive indices of about 1.2 to 1.6, and the insulating layer materials have refractive indices of about 1.4 to 1.7. Materials for the insulating layer and the electrolyte layer are appropriately selected from these materials such that the refractive index difference between the insulating layer and the electrolyte layer is low.

In order to that light passed through each opening satisfies the diffraction conditions, the optical path lengths in each opening need to be approximately the same, as described above. In addition to the above-described issues of the refractive index, the actual optical path distances are required to be uniform. In order to achieve this, the distances of the openings from the substrate are approximately the same, which can be realized by arranging the electrodes in the openings, i.e., in the discoloring portion, so as to be the same in every opening. That is, in the electrode arrangement shown in FIG. 2A, arrangement of the electrode 2a and the electrode 2b in this order is used in every discoloring portion, in FIG. 2B, arrangement of the electrode 2a, the electrode 2b, and the electrode 2a in this order is used in every discoloring portion, and in FIG. 2C, arrangement of the electrode 2a, the electrode 2b, the electrode 2a, and the electrode 2b in this order is used in every discoloring portion for preventing the optical path difference from occurring.

FIG. 2D shows the state when a coloring potential is applied to all electrode gratings. The whole EC layer is colored, the diffraction grating disappears, and light does not pass therethrough. When the EC layer material has a property of absorbing light only in a specific wavelength region in the coloring state, the optical element can also be used as a wavelength filter. In contrast, application of a discoloring potential to all electrode gratings discolors the entire EC layer to transmit light. In this occasion, the transparent electrode layer causing slight absorption of light has approximately a uniform thickness and thereby hardly causes a transmittance distribution in the optical path.

A specific example of the optical element having the above-described structure will now be described.

In FIG. 1A, an ITO film having a thickness of 100 nm is formed as the grating electrode 2a portion on a glass substrate 1a, a tungsten oxide film having a thickness of 200 nm is formed as the EC layer 4 on the ITO film, and the films are patterned into lines having a width of 500 nm at a pitch of 1000 nm. A SiO₂ insulating film having a thickness of 400 nm is formed as the grating electrode 2b portion between the grating electrodes 2a, an ITO film having a thickness of 100 nm is formed on each SiO₂ insulating film, and a tungsten oxide film having a thickness of 200 nm is further formed as the EC layer 4 in a linear pattern. Electrode gratings are wired such that a voltage can be applied to every four electrode sets, each set consisting of adjacent electrode 2a and electrode 2b.

An ITO film having a thickness of 100 nm is formed as the counter electrode 3 on the entire surface of the opposing substrate. The substrates are sealed to each other via a spacer 7 such that the electrode sides are the inside. The interior is filled with a 0.1 M solution of lithium perchlorate in propylene carbonate as an electrolyte liquid to form an optical element.

The optical element is used for red laser light having a wavelength of 633 nm at normal incidence. The insulating material SiO₂ and propylene carbonate have refractive indices for a wavelength of 633 nm of 1.45 and 1.41, respectively. Accordingly, the difference between the optical paths of light passing through the grating electrode 2a portion and light passing through the grating electrode 2b portion in each opening of the diffraction grating is 16 nm, which is sufficiently small. Thus, influence of the optical path difference in the wavelength hardly occurs.

In this optical element, as shown in FIG. 2A, a coloring potential of −1 V and a discoloring potential of 1 V are alternately applied to electrode sets, each set consisting of adjacent electrode 2a and electrode 2b. The counter electrode is grounded. As a result, the EC layer at the portion where the coloring potential is applied is colored to blue to generate a diffraction grating having a pitch of 2000 nm. Normal incidence of red laser light having a wavelength of 633 nm on this diffraction grating causes appearance of 1st. order diffracted light in the direction of about 18.5° from the incident direction.

As shown in FIG. 2B, a diffraction grating having a pitch of 3000 nm appears by alternately applying a discoloring potential of 1 V and a coloring potential of −1 V to electrode sets, each set consisting of adjacent grating electrodes 2a, 2b, and 2a or adjacent grating electrodes 2b, 2a, and 2b. As in above, normal incidence of red laser light having a wavelength of 633 nm on this diffraction grating causes appearance of 1st. order diffracted light in the direction of about 12.2° from the incident direction.

Furthermore, as shown in FIG. 2C, a diffraction grating having a pitch of 4000 nm appears by alternately applying a coloring potential and a discoloring potential to electrode sets, each set consisting of adjacent electrodes 2a, 2b, 2a, and 2b. Normal incidence of red laser light having a wavelength of 633 nm causes appearance of 1st. order diffracted light in the direction of 9.1° from the incident direction.

In addition, as shown in FIG. 2D, the diffraction grating disappears by applying a discoloring voltage of 1 V to all grating electrodes to make the optical element approximately transparent. Reversely, the entire surface is colored by applying a coloring voltage of −1 V to all grating electrodes.

Use of the optical element of this Example in an optical system allows, for example, switching of ON/OFF of light in the optical system, changing of the optical path, or selective extraction of light having a specific wavelength.

### Example 2

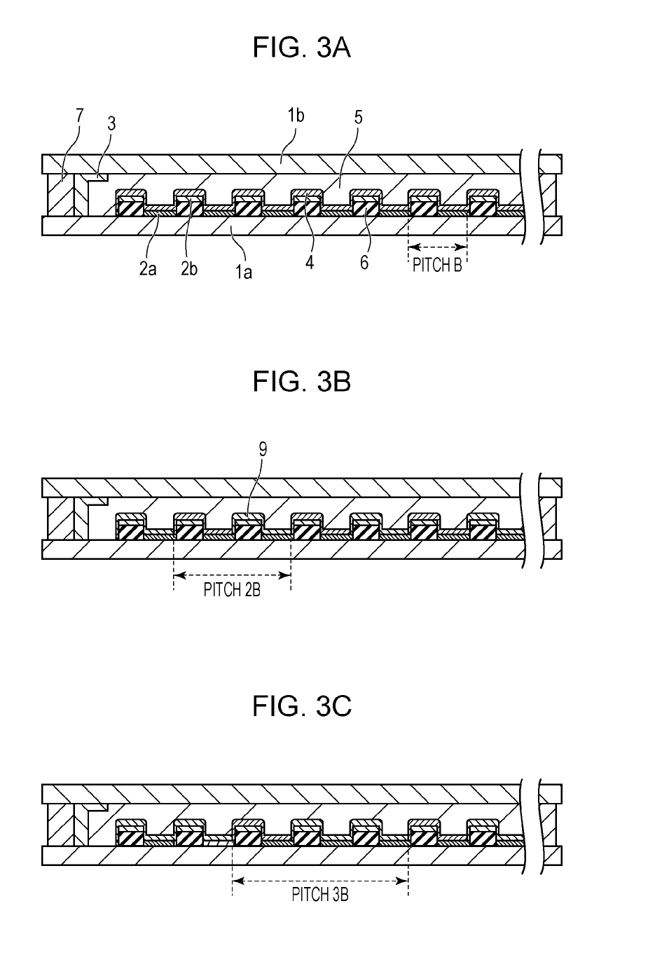

FIGS. 3A to 3C are schematic cross-sectional views of the optical element in Example 2 of the present invention. FIG. 3A illustrates a discoloring state, and FIGS. 3B and 3C illustrate the coloring states of the appearing diffraction gratings having pitches of 2B and 3B, respectively. As in Example 1, electrodes 2a and 2b and insulating layer 6 are formed by patterning on a substrate, and an EC layer 4 is then formed by, for example, electrolytic polymerization. As a result, the EC layer is formed also on the side surfaces of the electrodes 2b. When a coloring potential is applied to the electrodes 2b, the side walls are also colored. Accordingly, the electrode width is determined with consideration of this point.

The counter electrode 3 is disposed outside the optical path on the opposing substrate and on the side surface of the spacer. Since the transparent electrode material such as ITO slightly absorbs visible light, the light use efficiency of the element is increased by disposing the counter electrode 3 outside the optical path.

A specific embodiment is shown below. An ITO film formed on a glass substrate 1a is patterned into transparent electrodes 2a having a width of 600 nm and a thickness of 100 nm to form a diffraction grating pattern having a pitch of 1000 nm. SiO₂ insulating layers 6 each having a width of 400 nm and a thickness of 300 nm are formed in the spaces between the electrodes 2a, and ITO electrode layers 2b having a thickness of 100 nm are formed on the respective insulating layers 6.

The substrate 1a is immersed in a solution prepared by dissolving 0.01 M polypropylenedioxythiophene and 0.1 M tetrabutylammonium perchlorate in acetonitrile, and a voltage of 2.3 V is applied to all coloring electrodes to form a film of polypropylenedioxythiophene on the electrodes by electrolytic polymerization. The film can have a thickness of about 200 nm by the immersion for 1000 seconds. This film is the EC layer 4 and is formed also on the side surfaces of the electrodes. The protrusion of the EC layer onto the electrode 2b has a width of about 600 nm.

The other substrate 1b is provided with a carbon electrode 3 in the periphery of the optical path and is bonded to the substrate provided with the diffraction grating pattern via the spacer 7 similarly provided with the carbon electrode on the inner surface. The interior is filled with a 0.1 M solution of lithium perchlorate in propylene carbonate as the electrolyte 5.

An electrode 2a and the adjacent electrode 2b are used as one set. The coloring portion becomes blue showing an absorption peak at 580 nm by alternately applying a coloring voltage of 2 V and a discoloring voltage of −1.3 V to the sets. As a result, as shown in FIG. 3B, a diffraction grating having a pitch of 2000 nm appears. In addition, as shown in FIG. 3C, a diffraction grating having a pitch of 3000 nm appears by alternately repeating coloring and discoloring such that one electrode set is colored and the adjacent next electrode set is discolored.

### Example 3

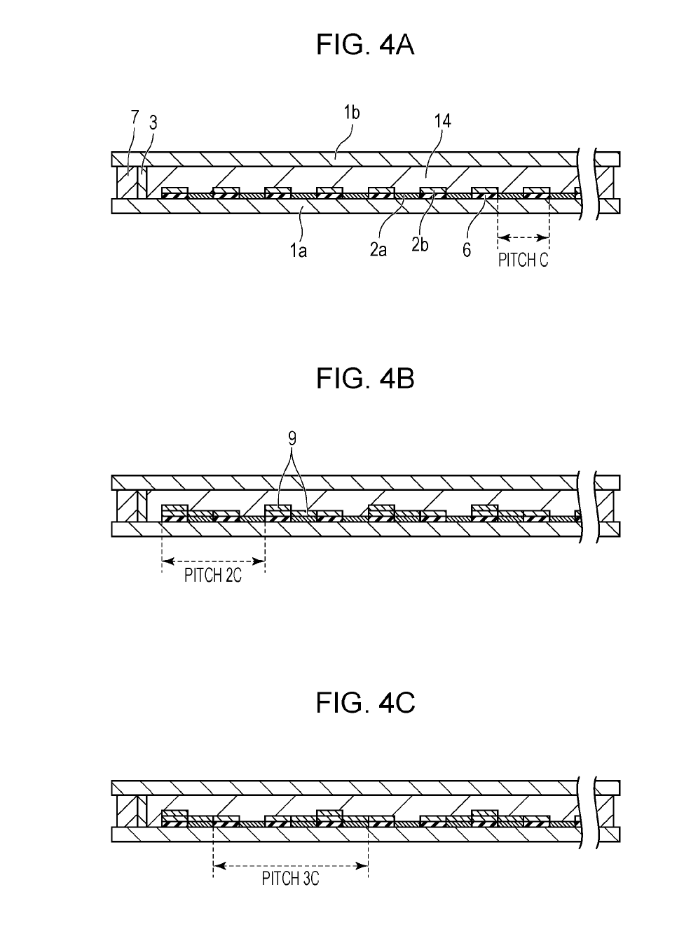

An example of applying the present invention to an optical element including a solution precipitation-type electrochromic material will be described. FIGS. 4A to 4C are schematic cross-sectional views of the optical element in Example 3 of the present invention. FIG. 4A illustrates a discoloring state, and FIGS. 4B and 4C illustrate the coloring states in which diffraction gratings having pitches of 2C and 3C, respectively, appear.

As in Example 1, an electrode pattern is formed such that electrode layers 2a of a transparent electrode material formed on a glass substrate 1a and electrode layers 2b formed on an insulating layers 6 are alternately arranged. The insulating layer 6 has a thickness larger than the thickness of the electrode layer 2a, and it is possible to apply different voltages to the electrode layers 2a and 2b. This substrate and another substrate 1b provided with a counter electrode 3 of a transparent electrode material are bonded to each other via a spacer 7 and sealed. The interior is filled with a solution precipitation-type electrochromic material 14.

As in Example 1, the difference between the optical paths of light passing through the electrode 2b portion and light passing through the electrode 2a portion needs to be sufficiently low. When the electrode layers 2a and 2b have approximately the same thicknesses, as in Example 1, it is necessary that the refractive index n(E) of the electrolyte layer, the wavelength λ and the incident angle θ of incident light, and the refractive index n(I) and the thickness T(I) of the insulating layer satisfy Expression (2). Accordingly, the influence of the optical path difference can be reduced by appropriately selecting, as the material for the insulating layer, a material having a refractive index showing a less difference with that of the electrolyte and appropriately selecting film thickness and incident angle.

A specific example of the element structure is shown below. Electrodes 2a having a width of 500 nm and a thickness of 200 nm are formed with a transparent electrode material ITO to give a grating electrode pattern with intervals of 1000 nm. SiO₂ insulating layers 6 each having a thickness of 300 nm are formed in the spaces between the electrodes 2a, and ITO electrode layers 2b having a thickness of 100 nm are formed on the respective insulating layers 6. The counter electrode 3 is disposed outside the optical path.

The EC material solution is prepared by saturating AgI in a solution of 0.002 M KI in 1 M dimethylsulfoxide. Dimethylsulfoxide and SiO₂ have refractive indices of 1.48 and 1.45, respectively. Accordingly, the difference between the optical paths of light passing through the electrode 2a portion and light passing through the electrode 2b portion is negligibly low.

A coloring potential of 3.2 mV and a discoloring potential of −2.8 V are applied to each electrode grating of the optical element according to a desired diffraction grating pattern. As a result, a black material precipitates on the grating electrodes applied with the coloring potential to generate a diffraction grating as shown FIG. 4B or 4C. FIG. 4B shows appearance of a diffraction grating having a pitch of 1500 nm, and FIG. 4C shows appearance of a diffraction grating having a pitch of 2000 nm.

Incidence of red laser light having a wavelength of 633 nm into the diffraction grating shown in FIG. 4B with an angle of 30° from the orthogonal direction causes appearance of 1st. order diffracted light in the direction of 25.0° from the orthogonal direction, and in the diffraction grating in FIG. 4C, 1st. order diffracted light appears in the direction of 18.5° from the orthogonal direction.

### Example 4

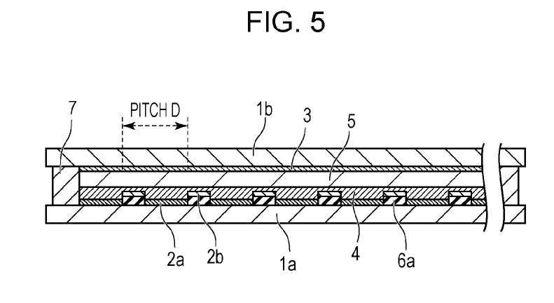

FIG. 5 shows an example using a solid electrochromic material. In this Example, as in Example 1, grating electrodes appear by alternately arranging a linear pattern of transparent electrode layers 2a formed on a substrate 1a and a linear pattern of transparent electrode layers 2b formed on linear insulating layers 6a formed on the substrate 1a. The insulating layer 6a has a thickness larger than the thickness of the electrode layer 2a, the adjacent electrodes 2a and 2b have different distances from the substrate due to the insulating layer and thereby can be applied with different voltages. A solid EC layer formed on the electrode layer 2a portion and the electrode 2b portion varies its thickness so as to have a flat surface. The surface of the EC layer is colored by applying a coloring potential to the electrode layer. Accordingly, in the state of generating a diffraction grating, the opening positions are horizontal with respect to the substrate, and an optical path difference due to the opening position does not occur in the transmitted light.

However, in the electrode layer 2a portion and the electrode layer 2b portion, the materials and the layer thicknesses are different such that the thickness of the EC layer on the electrode layer 2a differs from the thickness of the EC layer on the electrode layer 2b and that the insulating layer 6a is disposed in the electrode layer 2b portion. Therefore, there is a problem of causing an optical path difference due to the difference in refractive index of the materials. When the electrode layers 2a and 2b have approximately the same thicknesses as in Example 1, the problem can be solved by satisfying an expression where the refractive index n(EC) is used in place of the refractive index n(P) of the electrolyte layer in Expression (1). Accordingly, the influence of the constituent materials can be reduced by selecting, as the material for the insulating layer, a material having a refractive index near that of the EC material. Alternatively, in order to eliminate the refractive index difference, the insulating portion may be made of the EC material.

In this optical element, the color density of the EC layer on the grating electrode 2b portion and the color density of the EC layer on the grating electrode 2a portion may be different from each other even if the same coloring potential is applied. In such a case, the density can be uniformized by controlling the coloring potential. Furthermore, in the coloring state, the coloring region of the EC layer on the grating electrode 2a portion is larger than that of the EC layer on the grating electrode 2b portion. Therefore, it is necessary to form an electrode pattern with consideration of this in production of an optical element.

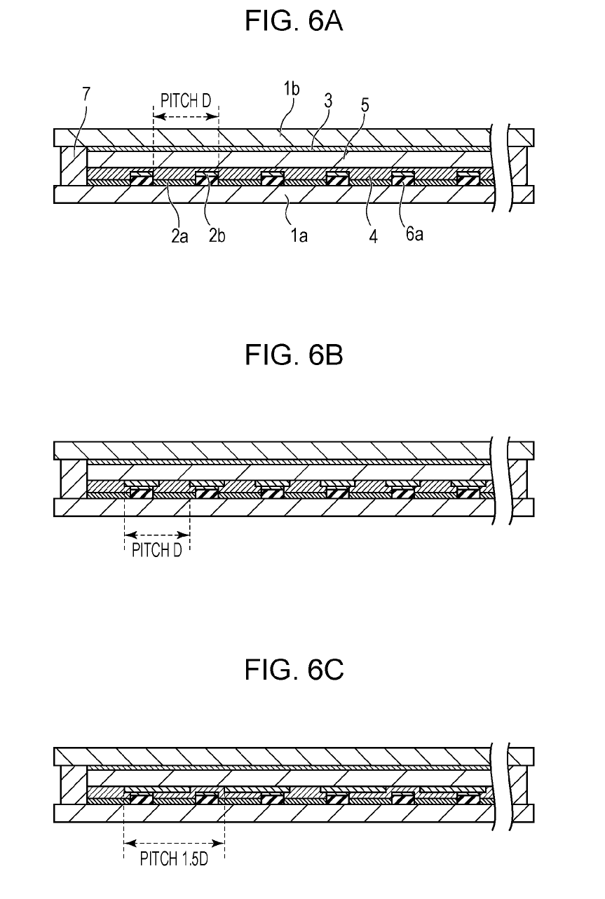

FIGS. 6A to 6C are schematic diagrams illustrating an optical element having an insulating layer made of an EC material.

FIG. 6A illustrates a discoloring state, and FIGS. 6B and 6C illustrate the coloring states of the appearing diffraction gratings having pitches of D and 1.5D, respectively. An ITO film formed on a substrate 1a is patterned into transparent electrodes 2a having a width of 800 nm and a thickness of 100 nm with intervals of 200 nm to form a diffraction grating pattern. Subsequently, an EC material, conductive polyaniline, is spin-coated thereon as a flat insulating layer 6a so as to fill the space between the electrodes 2a and to be further higher than the electrodes 2a by 100 nm, i.e., to have a thickness of 200 nm from the substrate. Electrodes 2b having a width of 200 nm and a thickness of 100 nm are formed with intervals of 800 nm so as to lie between the electrodes 2a made of the ITO layer in a diffraction gating form. Furthermore, an EC layer 4 of conductive aniline film having a thickness of 200 nm is formed by spin coating thereon. The formed electrodes are wired according to a desired diffraction grating pattern.

A transparent ITO electrode having a thickness of 100 nm is formed on another substrate 1b in the optical path. A solution of 1 M polyethylene oxide, which is a polymer matrix, and 0.2 M lithium peroxide dissolved in acetonitrile is applied as a solid electrolyte layer to the substrate provided with the electrodes and the EC pattern, followed by drying. Both substrates are press-bonded to each other to form an optical element.

The surface of the EC layer 4 on the grating electrodes 2b are colored to blue by applying a coloring potential of −1.8 V to the grating electrodes 2b of the optical element and a discoloring potential of 1.8 V to the grating electrodes 2a. As a result, a diffraction grating having a pitch of 1600 nm appears. The coloring portion on the electrode grating 2b is colored in a region broader than the pattern width, and thereby the width of the coloring portion and the width of the discoloring portion are approximately the same. Normal incidence of white light on the diffraction grating provides diffracted light having a wavelength of 415 nm in the direction of a diffraction angle of 15°.

In contrast, as shown in FIG. 6C, a diffraction grating having a pitch of 2400 nm appears by alternately repeating coloring and discoloring such that two grating electrodes are colored and the adjacent next one electrode is discolored. Incidence of white light on this diffraction grating provides diffracted light having a wavelength of 621 nm in the direction of a diffraction angle of 15°. Thus, the use of the diffraction grating of the present invention in an optical system allows production of monochromatic light from white light and also diffraction at a certain diffraction angle of light having different wavelengths, by shifting the pitch of the diffraction grating.

As an example of forming the insulating layer with a material other than EC materials, as in FIG. 5, an EC layer of polyaniline and an insulating layer of aluminum oxide can be employed. Polyaniline and aluminum oxide have refractive indices of 1.58 and 1.63, respectively. Therefore, the influence by the refractive index difference can be reduced.

### Example 5

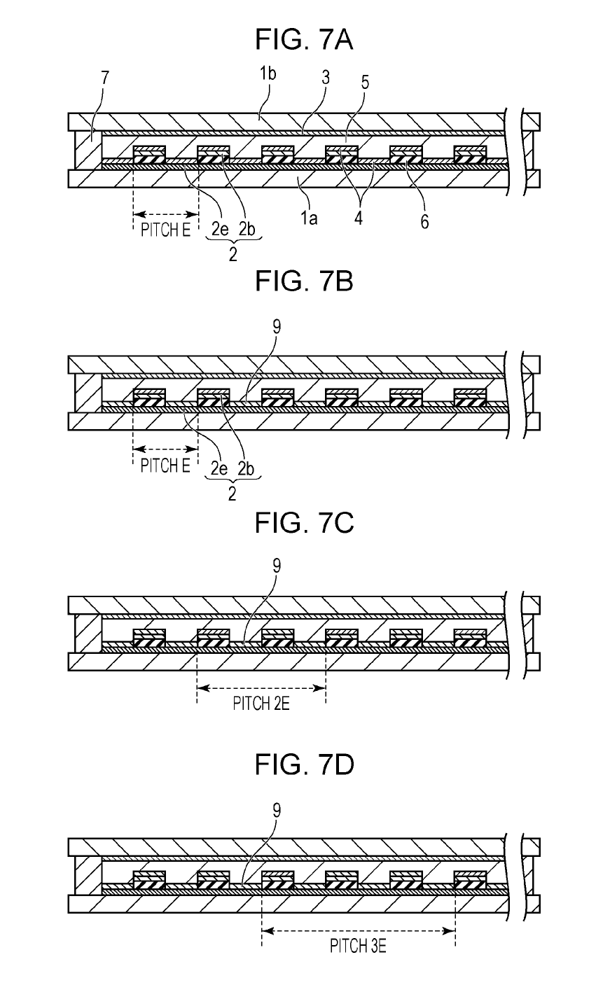

FIGS. 7A to 7D are schematic diagrams illustrating the optical element in Example 5 of the present invention. FIG. 7A illustrates a discoloring state, and FIGS. 7B, 7C, and 7D illustrate the coloring states of the appearing diffraction gratings having pitches of E, 2E, and 3E, respectively. In this Example, an electrode 2e is formed on a substrate in a broad area so as to spread over a plurality of gratings. Electrode layers 2b are formed in a linear pattern with intervals of E on the electrode 2e with an insulating layer 6 therebetween. As a result, the distance from the substrate of the patterned electrode 2b is different from that of the adjacent electrode 2e. The electrode 2e, the insulating layer 6, and the electrode 2b have thicknesses of 200 nm, 300 nm, and 200 nm, respectively. EC layers 4 are formed on the electrodes 2b and on the electrodes 2e between the patterned electrodes 2b. Only the EC layers on the electrodes 2e are colored by applying a coloring potential to the electrodes 2e and a discoloring potential to the electrodes 2b (FIG. 7B). By reversely applying potentials, only the electrodes 2b are colored. In both states, the diffraction grating has a pitch E.

As shown in FIG. 7C, a diffraction grating having a pitch 2E appears by applying a coloring potential to the electrodes 2e and alternately applying a coloring potential and a discoloring potential to the electrodes 2b. As shown in FIG. 7D, a diffraction grating having a pitch 3E appears by applying a coloring potential to the electrodes 2e and applying a discoloring potential to every three electrodes 2b and a coloring potential to the remaining two electrodes 2b between the every three electrodes 2b.

In this optical element, the degree of freedom in variation of the grating pitch is low, but any uncolored portion does not occur in the coloring portion when the grating pitch is changed, and unnecessary diffracted light does not occur. In addition, there is an advantage that entire coloring and entire discoloring are possible.

In the transmission type diffraction gratings in Examples 1 to 5, the counter electrode on the other substrate may be replaced by a diffraction grating pattern so that diffraction gratings on both sides can be used by switching them.

### Example 6

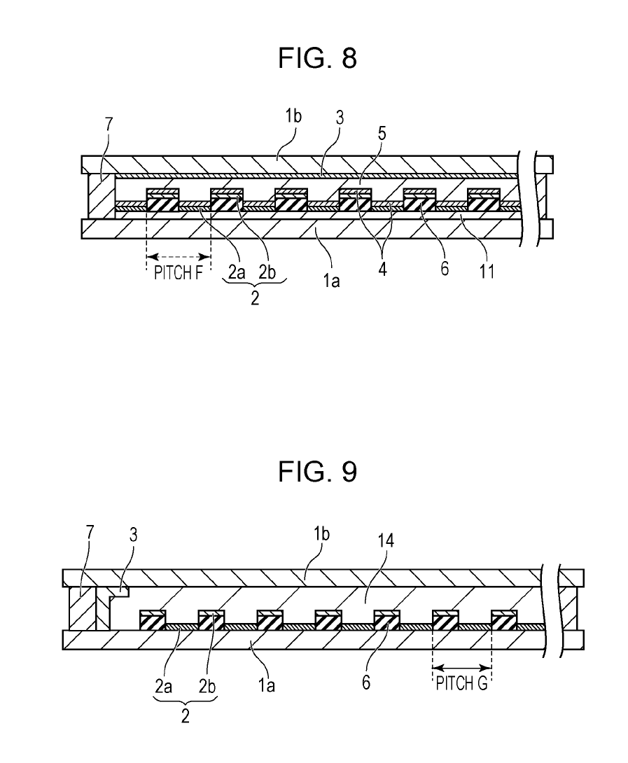

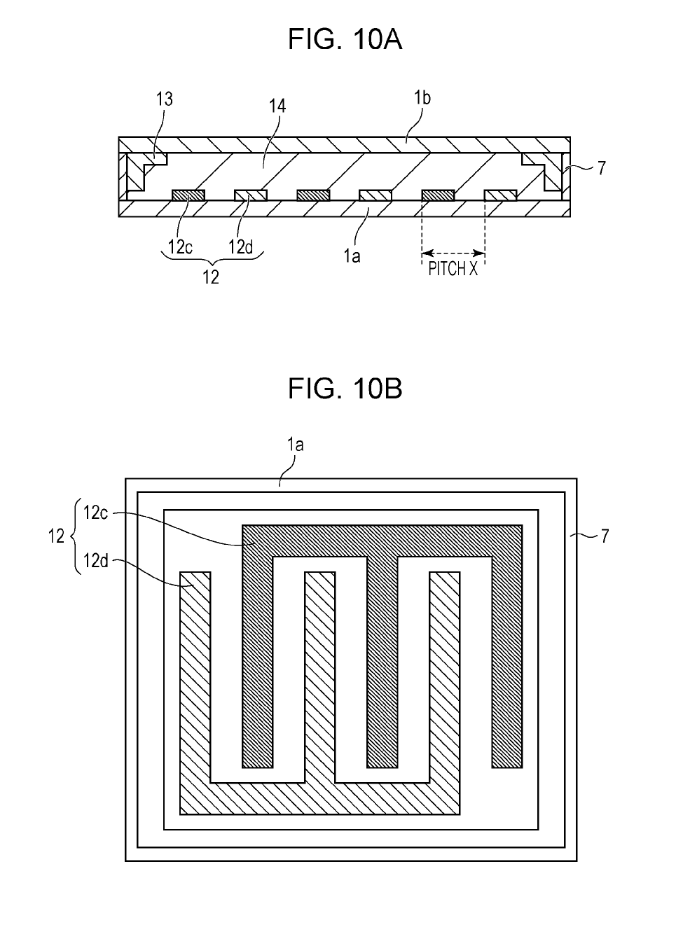

FIG. 8 shows a reflection type diffraction grating in Example 6 of the present invention. A reflection film 11 that reflects light having a wavelength used is disposed on the substrate on the coloring electrode side. As in Example 1, linearly patterned transparent electrode layers 2a are disposed on the reflection film 11, and EC layers 4 are disposed on the electrode layers 2a. Between the electrodes 2a, insulating layers 6, transparent electrode layers 2b, and solid EC layers 4 are disposed in this order on the reflection film 11. Other components such as counter electrode, electrolyte layer, and wiring are the same as those in Example 1. The transparent electrode layer 2a, the insulating layer 6, and the transparent electrode layer 2b have thicknesses of 100 nm, 400 nm, and 100 nm, respectively.

The reflection film 11 can be, for example, a metal reflection film or a dielectric reflection film. In the case of using a metal film, an insulating layer is formed between the metal film and the electrode layer 2a thereon.

In this optical element, the EC layers on the electrodes 2b are colored and the EC layers on the electrodes 2a become transparent to generate a diffraction grating having a pitch F by applying a coloring potential to the electrodes 2b and a discoloring potential to the electrodes 2a. Incident light on the counter electrode side passes through the uncolored EC layers and the electrodes 2a and is reflected by the reflection film 11 under the electrodes, and the reflected light passes through the electrodes 2a and the EC layers again and is emitted to the outside of the optical element.

When a discoloring potential is applied to the electrodes 2b, incident light passes through the uncolored EC layers, the electrodes 2b, and the insulating layer and is reflected by the reflection film, and the reflected light passes through the insulating layer, the electrodes 2b again and is emitted to the outside of the element. Therefore, a difference between the optical paths of the reflected light passing through the electrode 2a and the reflected light passing through the electrode 2b occurs due to the difference in refractive index of the materials lying in the optical path.

In order to increase the degree of freedom in variation of the pitch of a diffraction grating, the electrode 2a and the electrode 2b in the opening portion can be used in combination without causing the optical path difference. The optical path difference hardly occurs when the difference between the refractive indices of the insulating layer and the electrolyte layer is low. Alternatively, the diffraction condition is maintained when the optical path difference is integral multiplication of the wavelength. As in Example 1, for example, when an electrolyte layer of propylene carbonate and an insulating layer of SiO₂ or SiN are used, the optical path difference is negligible. The thicknesses of the layers formed on the reflection film, such as the insulating layer and the electrode layer, are controlled not to prevent the reflection conditions.

As described above, in the diffraction gratings in Examples 1 to 6, the pitch can be changed to not only integral multiplication, but also, for example, 1.33 times or 1.5 times the basic pitch. In addition, the pitch can be changed to another one by varying the combination of grating widths. Thus, the degree of freedom in variation of the grating pitch is high. Furthermore, the ratio of the opening portion to the shielding portion can be changed when the grating pitch is changed. Therefore, high monochromaticity can be provided, and unnecessary diffracted light due to diffraction grating having the basic pitch does not occur. Furthermore, it is possible to prevent uneven transmittance in the optical path and occurrence of diffraction thereby due to absorption of the transparent electrode portion during the overall discoloring.

### Example 7

In the diffraction grating of the present invention, polarization properties are obtained by reducing the pitch between the coloring electrodes to be smaller than the wavelength of light. FIG. 9 shows an optical element using a solution precipitation-type EC element as a phase plate. The electrode pattern shown in FIG. 9 is formed using IZO for the electrodes 2 (2a and 2b) and SiO₂ for the insulating layer 6 such that the electrode 2a and the electrode 2b have width of 200 nm and 150 nm, respectively. The thicknesses of the electrode 2a, the insulating layer, and the electrode 2b are 100 nm, 200 nm, and 100 nm, respectively. The EC material solution is prepared by saturating AgI in a solution of 0.002 M KI in 1 M dimethylsulfoxide. The counter electrode is disposed outside the optical path. Dimethylsulfoxide and SiO₂ have refractive indices of 1.48 and 1.45, respectively. Accordingly, the difference between the optical paths of the light passing through the electrode 2a portion and the light passing through the electrode 2b portion is negligibly low.

A black material precipitates on the electrodes 2b by applying a potential of 3.2 V to the electrode 2b portion and a potential of −2.8 V to the electrode 2a portion. As a result, a diffraction grating pattern having a pitch of 350 nm appears, and polarization properties are generated. The grating pattern disappears by applying a negative voltage to the electrodes 2a and 2b, and the polarization properties are also lost. The electrodes 2a and 2b are wholly colored by applying a positive voltage to the electrodes, and the optical element functions as a beam stopper.

The color density of the electrode portion is changed by varying the voltage applied to the electrode 2b portion. This allows a change of the degree of polarization.

Based on this Example, a wave plate that can generate and extinguish the polarization properties and can adjust the degree of polarization can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-099135, filed Apr. 24, 2012, which is hereby incorporated by reference herein in its entirety.

### INDUSTRIAL APPLICABILITY

The optical element of the present invention can generate and extinguish a diffraction grating and can change the grating pitch of the appearing diffraction grating. Accordingly, the optical element can be used, for example, for selecting a wavelength or switching the optical path in an optical device, in particular, in a small-sized optical device.

### REFERENCE SIGNS LIST

1a substrate or transparent substrate
1b substrate or transparent substrate
2 coloring electrode or electrode
2a electrode formed near the substrate
2b electrode formed distant from the substrate
2e electrode formed near the substrate over a plurality of gratings
3 counter electrode
4 EC layer
5 electrolyte layer
6 insulating layer
6a insulating layer
7 spacer
8 wiring of coloring electrode
9 coloring portion
10 discoloring portion
11 reflection film
12 coloring electrode
12c electrode
12d electrode
13 counter electrode
14 electrochromic solution

1. An optical element comprising:
a pair of opposing substrates,
a plurality of electrodes arranged on one of the substrates,
an electrochromic layer disposed so as to be in contact with the plurality of electrodes, and
a counter electrode disposed so as to oppose the plurality of electrodes with the electrochromic layer therebetween,
wherein one of two adjacent electrodes in the plurality of electrodes is provided with an insulating layer between the electrode and the substrate; and
the insulating layer has a thickness larger than that of the other electrode of the two adjacent electrodes.

2. The optical element according to claim 1, wherein the adjacent electrodes in the plurality of electrodes have different distances from the substrate.

3. The optical element according to claim 1, wherein the adjacent electrodes in the plurality of electrodes have regions overlapping each other.

4. The optical element according to claim 1, wherein the plurality of electrodes are patterned electrodes and generate a diffraction grating by being applied with a coloring voltage and a discoloring voltage.

5. The optical element according to claim 1, wherein openings lying between the gratings of the diffraction grating of the plurality of electrodes and serving as discoloring portions have substantially the same distances from the substrate.

6. The optical element according to claim 1, wherein
the electrochromic layer is made of a solid electrochromic material;
an electrolyte layer is disposed so as to be in contact with the electrochromic layer; and
when the thicknesses of the plurality of electrodes having different distances from the substrate are the same, and the thicknesses of the solid electrochromic layers are the same, the refractive index n(I) and the thickness T(I) (nm) of the insulating layer satisfy the relationship of Expression (1):

|(n(P)/(1−(sin θ/n(P))²)^{1/2}−n(I)/(1−(sin θ/n(I))²)^{1/2})×T(I)|≦(n±¼)λ (1),
wherein, n in (n±¼) represents an integer of 0 or more; n(P) represents the refractive index of the electrolyte layer; λ represents the wavelength (nm) of incident light; and θ represents the incident angle (°) from the direction orthogonal to the optical element.

7. optical element according to claim 1, wherein the electrochromic layer is made of a solution precipitation-type electrochromic material; and
when the thicknesses of the plurality of electrodes having different distances from the substrate are the same, the refractive index n(I) and the thickness T(I) (nm) of the insulating layer satisfy the relationship of Expression (2):

|(n(E)/(1−(sin θ/n(E))²)^{1/2}−n(I)/(1−(sin θ/n(I))²)^{1/2})×T(I)|≦(n±¼)λ (2),
wherein, n in (n±¼) represents an integer of 0 or more; n(E) represents the refractive index of the electrochromic layer; λ represents the wavelength (nm) of incident light; and θ represents the incident angle (°) from the direction orthogonal to the optical element.

8. optical element according to claim 1, wherein
a diffraction grating appears by selectively applying a coloring voltage to some of the patterned electrodes and applying a discoloring voltage to the remaining electrodes;
the grating pitch of the appearing diffraction grating is varied by changing the combination of the electrodes applied with the coloring voltage and the electrodes applied with the discoloring voltage;
the diffraction grating disappears by applying a discoloring voltage to all electrodes to transmit incident light and disappears by applying a coloring voltage to all electrodes to absorb, diffuse, or reflect incident light.
